(19) United States
(12) Patent Application Publication
(10) Pub. No.: US 2025/0048330 A1
(43) Pub. Date: Feb. 6, 2025

(54) Method for obtaining a value of a variable representative of a movement of a mobile terminal, device and corresponding computer program

(71) Applicant: ORANGE, Issy-les-Moulineaux (FR)

(72) Inventors: Rémy Scholler, CHÂTILLON CEDEX (FR); Denis Renaud, CHÂTILLON CEDEX (FR)

(21) Appl. No.: 18/714,788

(22) PCT Filed: Nov. 23, 2022
(86) PCT No.: PCT/EP2022/083054

§ 371 Date: May 30, 2024

(30) Foreign Application Priority Data
Nov. 30, 2021 (FR) FR2112774

(51) Int. Cl. H04W 64/00; H04W 4/029

(52) U.S. Cl. CPC H04W 64/006; H04W 4/029

(57) ABSTRACT

There are a number of techniques for estimating a movement speed of a mobile terminal by means of signalling data. According to these techniques, a position of the mobile terminal is estimated, approximated by the centre of a cell of a base station to which the mobile terminal is connected. To do this, use is made of a Voronoi partitioning of the territory covered by the cells. Each network event is then positioned at the centre of the cell in which it occurs. Such events are time-stamped, enabling a speed to be calculated. However, such techniques have the following limitations specific to Voronoi partitions. This solution goes against these methods, which first require estimating the two positions of the mobile terminal. The present solution helps to overcome this constraint by using a likelihood map of support by a base station.

### FIELD OF THE INVENTION

The field of the invention is that of the localisation of mobile objects connected to at least one communication network.

More specifically, the invention relates to a method for obtaining a value of a variable representative of a movement of a mobile terminal by means of the signalling data collected and the corresponding device, computer program and medium.

### PRIOR ART AND ITS DISADVANTAGES

The signalling data collected by a telecommunications operator within the communication network or networks it operates enables it to identify the use made by its users of the resources it makes available to them. Armed with this knowledge, a telecommunications operator can then plan development and maintenance operations for the equipment that makes up the communications networks it operates enabling it to meet the needs and expectations of its users.

In recent years, with the development of the Internet of Things (IoT) and the emergence of connected vehicles, telecoms operators have realised that the signalling data in their possession could be of interest to other players and that they were thus becoming an asset to value.

Signalling data from mobile terminals used during travelling is of particular interest for the study of human mobility, whether mobile terminals belonging to a user or mobile terminals embedded in a vehicle.

There are a number of techniques for estimating a movement speed of a mobile terminal. One of these various known techniques is used to estimate a movement speed of a mobile terminal by means of signalling data. According to this technique, the position of the mobile terminal is estimated, approximated by the centre of a coverage area, or cell, of a base station to which the mobile terminal is connected. To do this, use is made of a Voronoi partitioning of the territory covered by the cells making up a radio communication network. Each network event is then positioned at the centre of the cell in which it occurs. Such events are time-stamped, enabling a speed to be calculated based on the coordinates of the centres of the cells.

However, such a technique has the following limitations specific to Voronoi partitions:
all cells are assumed to be omnidirectional,
the characteristics of the cells (radiation power, height and inclination of the base station antennas) are not taken into account,
the overlap of action zones of the cells is not taken into account,
no location a priori is used.

The cells of a radio communication network sometimes cover large areas, e.g. with a radius of more than 5 km, so the position estimates obtained from mobile terminals used during travelling are very uncertain and so are the estimates of movement speed.

There is therefore a need for a solution that does not have all the above disadvantages for obtaining information representative of a movement of a mobile terminal by means of signalling data.

### SUMMARY OF THE INVENTION

The invention addresses at least partially this need by proposing a method for obtaining a value of a variable representative of a movement of a mobile terminal.

According to the present application, said method comprises:
associating with at least one first and one second network event involving said mobile terminal, a first, respectively second, time stamp of said first, respectively second, network event and a first, respectively second, likelihood map representing probabilities of connection of said mobile terminal to a first, respectively second, base station with which the mobile terminal interacted during said first, respectively second, network event in a first, respectively second, coverage area of said first, respectively second, base station,
determining a probability density of said variable representative of a movement of the mobile terminal according to a first position (X₁, Y₁) of the mobile terminal during the first network event, obtained by means of said first likelihood map, and a second position (X₂, Y₂) of the mobile terminal during said second network event, obtained by means of said second likelihood map,
obtaining, from the probability density of said variable representative of a movement of the mobile terminal, a value of said variable representative of a movement of the mobile terminal.

Thus, in some embodiments, such a method is particular in that, a network event involving said mobile terminal being associated with a set of signalling data comprising, among other things, an item of timestamp data of the event and a likelihood map of support by a base station with which the mobile terminal interacted during the event, said method comprises:
determining a probability density of said variable representative of a movement of the mobile terminal according to a first likelihood map of support by a base station associated with a first network event involving the mobile terminal, and a second likelihood map of support by a base station associated with a second network event involving the mobile terminal, obtaining, from the probability density of said variable representative of a movement of the mobile terminal, a value of said variable representative of a movement of the mobile terminal.

In the present application, network event is understood to mean any event giving rise to a transmission or a reception of signalling data between a mobile terminal and a base station of a communications network, such as the establishment of a call between the mobile terminal and the base station, for example in the event of an incoming or outgoing call or in the event of the transmission or reception of a short message or SMS, the triggering of a procedure for attachment to the base station, the transmission of a paging message to the mobile terminal asking it to wake up from a standby state, etc.

This approach goes against the conventional approach of determining a value of a variable representative of a movement of a mobile terminal from two precise positions of the mobile terminal, which first requires estimating the two positions of the mobile terminal.

The present solution helps to overcome this constraint by using a likelihood map of support by a base station.

Such a likelihood map of support by a base station represents the probability of a mobile terminal connecting to a base station at a location within the coverage area of the base station. Such a likelihood map does not correspond directly to a spatial probability density of the presence of the mobile.

These likelihood maps of support by a base station have the advantage of taking into account the direction of the cells, their radiation characteristics, the overlap of their action zones and use an a priori for locating mobile terminals, contrary to some techniques of the state of the art and more particularly to certain techniques using the Voronoi partitions.

In one example, the first event and the second event are selected from a plurality of network events involving the mobile terminal and occurring during a first time window.

This makes it possible to estimate the mobility conditions of terminal over a short time window in the order of one or more tens of minutes, for example 15 minutes, which is not the case with the techniques in the state of the art, which have difficulty extracting relevant information over short time windows because of their poor recognition of the uncertainties in locating mobile terminals. Moreover, this makes the present solution compatible with the legislative provisions relating to the retention of event logs relating to mobile terminals.

In one example, the method comprises at least two iterations of the step of determining and further comprises determining a combined probability density of said variable representative of a movement of the mobile terminal by combining the probability densities of said variable representative of a movement of the mobile terminal determined during each of said iterations, the value of said variable representative of a movement of the mobile terminal being thus obtained from said average probability density.

Increasing the number of pairs of events to be taken into account can help, at least in some embodiments, to improve the accuracy of estimating the value of a variable representative of a movement of a mobile terminal.

In one example, the first event and the second event are temporally spaced by at least one first duration.

An immobile terminal that is in a situation of immobility can sometimes attach itself to a base station that is not the closest to its position. This may be due to various factors: a building located in front of the antennae of the nearest base station hindering the propagation of the signal, an overload on the base station, a window facing a more distant base station making it easier to attach to it, etc.

Very often, this type of base station change or “hand-over” occurs in a short period of time, for example ranging from a few seconds to a few minutes, and an attachment of the mobile terminal to the nearest base station is then observed. This is referred to as an cell oscillation phenomenon. This phenomenon thus generates a noise inherent in the operation of a radio network.

This cellular oscillation phenomenon can also occur with mobile terminals that are in a situation of mobility. A sudden deviation from the global mobile trace of the mobile terminal (sequence of cells over time) can be observed. A cell oscillation corresponds to a slight actual movement, and to a more or less large “hop” at the radio communication network level. If the “hop” at the radio communication network level is small, this has little impact on the observed behaviour of the mobile terminal. On the other hand, if the “hop” is large, it can add “noise” to the observed behaviour of the mobile terminal, and can even give the impression of a false situation of mobility in some cases.

The cellular oscillation phenomenon can therefore make a “hop” seem like an event to be taken into account when estimating the value of a variable representative of a movement of a mobile terminal. This cellular oscillation phenomenon can be frequent and can give rise to highly spread out or offset probability densities for speed towards high speeds, resulting in aberrant speed measurements.

To mitigate these effects, the present solution proposes a certain period of time to separate the events constituting a pair of events.

Another way of mitigating the network oscillation phenomenon is to impose a maximum distance between the base stations involved in the events considered. For example, two events that are 1,000 km apart are excluded.

In another example, the variable representative of a movement of a mobile terminal is a movement speed of the mobile terminal.

When the variable representative of a movement of a mobile terminal is a movement speed of the mobile terminal, the probability density of said variable representative of a movement of the mobile terminal is determined by means of a density of a distance travelled by the mobile terminal, obtained according to the first likelihood map of support by a base station and to the second map representative of a density of presence of the mobile terminal in a coverage area of a base station, and to a duration separating the first and second events.

In another example, the variable representative of a movement of a mobile terminal is a movement direction of the mobile terminal.

When the variable representative of a movement of a mobile terminal is a movement direction of the mobile terminal, the probability density of said variable representative of a movement of the mobile terminal is determined by means of a density of a value of an angle representative of a movement direction of the mobile terminal obtained according to the first likelihood map of support by a base station and to the second map representative of a density of presence of the mobile terminal in a coverage area of a base station.

The characteristics presented separately in the present application in relation to some embodiments of the method of the present application may be combined according to other embodiments of the present method.

According to another aspect, the present application also relates to an electronic device adapted to implement the method of the present application in at least one of its embodiments.

The invention also relates to an electronic device capable of obtaining a value of a variable representative of a movement of a mobile terminal.

According to the present application, said device comprises at least one processor adapted to:
associate with at least one first and one second network event involving said mobile terminal, a first, respectively second, time stamp of said first, respectively second, network event and a first, respectively second, “likelihood map” representing probabilities of connection of said mobile terminal to a first, respectively second, base station with which the mobile terminal interacted during said first, respectively second, network event in a first, respectively second, coverage area of said first, respectively second, base station,
determine a probability density of said variable representative of a movement of the mobile terminal according to a first position (X₁, Y₁) of the mobile terminal during the first network event, obtained by means of said first likelihood map, and a second position (X₂, Y₂) of the mobile terminal during said second network event, obtained by means of said second likelihood map,
obtain, from the probability density of said variable representative of a movement of the mobile terminal, a value of said variable representative of a movement of the mobile terminal.

Thus, in some embodiments, such a device is particular in that, a network event involving said mobile terminal being associated with a set of signalling data comprising, among other things, an item of timestamp data of the event and a likelihood map of support by a base station with which the mobile terminal interacted during the event, said device comprises at least one processor adapted to:
determine a probability density of said variable representative of a movement of the mobile terminal according to a first likelihood map of support by a base station associated with a first network event involving the mobile terminal, and a second likelihood map of support by a base station associated with a second network event involving the mobile terminal,
obtain, from the probability density of said variable representative of a movement of the mobile terminal, a value of said variable representative of a movement of the mobile terminal.

Such a device may, for example, be embedded in a server belonging to the telecoms operator operating the radio communication network to which the base stations belong.

The invention finally relates to a computer program product comprising program code instructions for implementing a method as described previously, in any one of its embodiments, when it is executed by a processor.

The invention also relates to a computer-readable storage medium on which is saved a computer program comprising program code instructions for implementing the steps of the method according to the invention as described above, in any one of its embodiments.

Such a storage medium can be any entity or device able to store the program. For example, the medium can comprise a storage means, such as a ROM, for example a CD-ROM or a microelectronic circuit ROM, or a magnetic recording means, for example a USB flash drive or a hard drive.

On the other hand, such a storage medium can be a transmissible medium such as an electrical or optical signal, that can be carried via an electrical or optical cable, by radio or by other means, so that the computer program contained therein can be executed remotely. The program according to the invention can be downloaded in particular on a network, for example the Internet network.

Alternatively, the storage medium can be an integrated circuit in which the program is embedded, the circuit being adapted to execute or to be used in the execution of the method of the above-mentioned invention.

### LIST OF FIGURES

Other purposes, features and advantages of the invention will become more apparent upon reading the following description, hereby given to serve as an illustrative and non-restrictive example, in relation to the figures, among which:

FIG. 1: this figure shows a diagram of the steps of a method for obtaining a value of a variable representative of a movement of a mobile terminal in a first example of implementation. In this first example, the variable representative of a movement of the mobile terminal is the movement speed,

FIG. 2A: this figure shows a likelihood map of support by a cell obtained on the assumption of an a priori uniform presence of the mobile,

FIG. 2B: this figure shows a likelihood map of support by a cell obtained on the assumption of an a priori presence of the mobile along a road and a high-speed train line,

FIG. 3: this figure shows the radius of action of an antenna of the corresponding base station, expressed in metres,

FIG. 4: this figure shows an example of such an average movement speed density of the mobile terminal,

FIG. 5: this figure shows a diagram of the steps of a method for obtaining a value of a variable representative of a movement of a mobile terminal in a second example of implementation,

FIG. 6: this figure shows a device capable of implementing certain steps of the solution described above.

### DETAILED DESCRIPTION OF THE EMBODIMENTS OF THE INVENTION

The general principle of the invention is based on the use of signalling data collected by a telecoms operator operating at least one radio communications network to estimate a variable representative of a movement of a mobile terminal within the radio communication network. More particularly, in the detailed embodiment, one element of the signalling data used in the present solution may be a likelihood map of support by a base station. As already explained above, such a likelihood map represents the probability of a mobile terminal connecting to a base station at a location within the coverage area of the base station. Thus, in at least some embodiments of the present method, the use of a likelihood map can help to improve the results obtained, compared with the solutions of the prior art, in terms of reliability, accuracy and/or realism.

Such knowledge can also help, for example, in a better classification of the different types of goods vehicles and their uses, and/or enable a better management of the fleets of bicycles or scooters made available to the public, a better tracking of postal parcels equipped with connected trackers, etc.

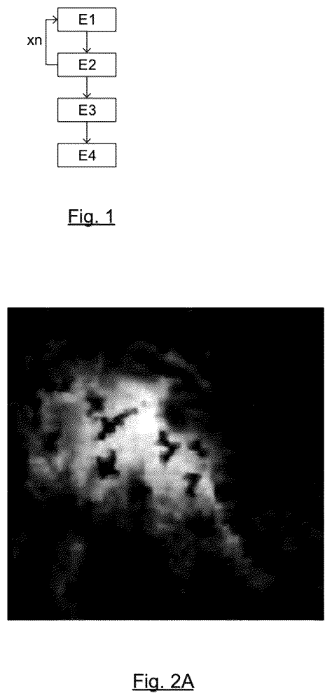

FIG. 1 shows a diagram of the steps of a method for obtaining a value of a variable representative of a movement of a mobile terminal in a first example of implementation. In this first example, the variable representative of a movement of the mobile terminal is the movement speed.

In a first phase, which can be implemented independently of the obtaining method, signalling data is collected, for example by means of probes placed in a radio communication network. This signalling data is then stored in one or more databases. In such a database, each entry corresponds, for example, to a network event.

In the detailed embodiments, the signalling data collected for a network event includes, but is not limited to:
a mobile terminal identifier (e.g. a pseudonym uniquely identifying the mobile terminal to the operator),
timestamp data for the occurrence of the network event,
an identifier for the base station or the cell that is associated with the network event.

In the detailed embodiments, enhanced signalling data can also be stored in the database. In this way, a network event can also be associated with a likelihood map of support by the cell associated with the base station with which the mobile terminal interacted during the occurrence of the event.

For example, a likelihood map of support by at least one cell of a base station, all the cells of a base station constituting the coverage area of the base station, can for example be obtained by simulation. For example, for a base station comprising an antenna Aᵢ, a support likelihood map can represent a connection probability P(Aᵢ|(X,Y)∈pₖ) of the mobile terminal to the antenna Aᵢ where pₖ is one of the map's pixels, at the coordinate point (X, Y) knowing that the mobile terminal is located on the pixel pₖ.

Such a likelihood map of support by at least one cell of a base station is obtained from a geographical map representative of the coverage area of the base station and at least one assumption on an a priori presence of the mobile chosen, for example, from a uniform presence, a presence along main roads, and/or a presence as a function of population density, etc. Such a geographical map representative of the coverage area of the base station is obtained, for example, by simulations. The a priori presence of the mobile chosen depends on the population of mobile terminals that are wanted to be monitored: an a priori presence of the mobile can be chosen when it is wanted to determine the speed over the entire coverage area of the base station, an a priori presence along roads can be chosen if it is wanted to determine the speed of mobile terminals onboard vehicles, an a priori presence can be chosen as a function of population density if it is wanted to monitor the movement of mobile terminals in residential areas.

Bayes formula is used to determine the probability that an event will occur knowing that another event has already occurred. Such a formula is written:

$$P ( {A}_{i} \vert ( X , Y ) ∈ {p}_{k} ) = \frac{P ( ( X , Y ) ∈ {p}_{k} ∩ {A}_{i} )}{P ( ( X , Y ) ∈ {p}_{k} )} = \frac{P ( {A}_{i} ) P ( ( X , Y ) ∈ {p}_{k} \vert {A}_{i} )}{P ( ( X , Y ) ∈ {p}_{k} )}$$

This formula is used to express the probability of a mobile terminal connecting to the antenna Aᵢ of the base station knowing that it is located on the pixel pₖ

Since the geographic map representing the coverage area of the base station is partitioned into pixels, the total probability formula can thus be used to obtain the probability of a mobile terminal being located on the pixel pₖ knowing that it is connected to the antenna Aᵢ of the base station:

$$P ( ( X , Y ) ∈ {p}_{k} \vert {A}_{i} ) = \frac{P ( ( X , Y ) ∈ {p}_{k} ) P ( {A}_{i} \vert ( X , Y ) ∈ {p}_{k} )}{P ( {A}_{i} )} = \frac{P ( ( X , Y ) ∈ {p}_{k} ) P ( {A}_{i} \vert ( X , Y ) ∈ {p}_{k} )}{{\sum }_{{k}^{′}} P ( ( X , Y ) ∈ {p}_{{k}^{′}} ) P ( {A}_{i} \vert ( X , Y ) ∈ {p}_{{k}^{′}} )}$$

$$\text{which is equivalent, by noting} P ( ( X , Y ) ∈ {p}_{k} ) = Prior ( k ) , to$$

$$P ( ( X , Y ) ∈ {p}_{k} \vert {A}_{i} ) = \frac{Prior ( k ) P ( {A}_{i} \vert ( X , Y ) ∈ {p}_{k} )}{{\sum }_{{k}^{}} Prior ( k ) P ( {A}_{i} \vert ( X , Y ) ∈ {p}_{{k}^{′}} )} .$$

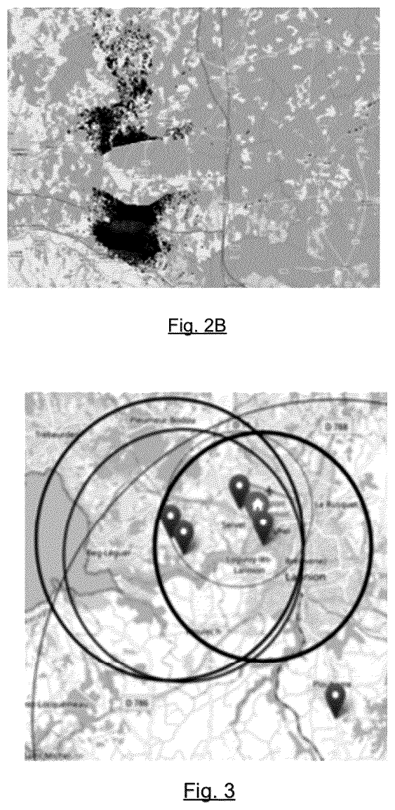

An example of such a likelihood map of support by a cell obtained with station obtained on the assumption of an a priori uniform presence of the mobile is shown in FIG. 2A.

Another example of such a likelihood map of support by a cell obtained on the assumption of an a priori presence of the mobile along a road and a high-speed train line is shown in FIG. 2B.

In some embodiments, an event can also be associated, in the database, with a value of a radius of action of an antenna of the corresponding base station, expressed in metres.

Thus, for each cell of a base station, it may be possible to define a radius of action R such that the probability of the presence of a mobile terminal in a disc of radius R around the centre of this cell, knowing the occurrence of a network event in this cell at a given time, is greater than or equal to 85%.

15 The radius of action R may, for example, highly depend on the technology used (according to whether it complies with 2^{nd}, 3^{rd}, 4^{th} (LTE) or 5^{th} generation telecommunications standards) and/or the type of geographic area concerned, e.g. rural, urban or suburban.

In other words, for an antenna Aᵢ whose coordinates on the geographic map are (xᵢ, yᵢ), having a radius of action Rᵢ, and noting D_{R}_{ᵢ} the disc of radius Rᵢ centred on the centre of the cell in question, there is:

P((X,Y)∈D_{R}_{ᵢ}|Aᵢ)≥85% noting (X, Y) the pair of random variables giving the position of the mobile terminal at time tᵢ.

FIG. 3 illustrates this notion of radius of action.

This method for obtaining a value of a movement speed of a mobile terminal is based on the use of signalling data relating to mobile terminals, and therefore to their users. Also, in certain implementation modes, its use must comply with regulatory data anonymisation and/or pseudonymisation constraints. In addition, these constraints can sometimes impose (relatively short) deadlines for data anonymisation and/or pseudonymisation. In some embodiments, the calculations to be performed use signalling data whose history (i.e. conservation) must not exceed a certain duration. Such as duration, or time window, is 15 minutes, for example.

In some embodiments, the method for obtaining a value of a movement speed of a mobile terminal may comprise (in a first step E1) a selection of a first network event ER1 and of a second network event ER2 from a plurality of network events ERᵢ involving the mobile terminal. Such a selection consists in taking all the pairs of network events such that the two network events ER1 and ER2 constituting a pair of network events are present in the time window considered, that they are separated by a minimal duration, which can be set to be in the order of a few seconds to a few minutes, for example 5 or 6 minutes, and are such that the network event ER2 is later than the network event ER1.

The first and second network events ER1, ER2 occur respectively at times t₁ and t₂ and involve the antennas A₁ and A₂ carried by two base stations which may be different.

For i∈{1,2} we denote (Xᵢ, Yᵢ) the random variables respectively giving the longitude and latitude of the mobile terminal at time tᵢ.

In the rest of the document, the following assumptions are made:
the random variables (Xᵢ, Yᵢ) associated with the probability densities of the presence of the two antennas A₁ and A₂ are independent,
the movement of the mobile terminal is assumed to be uniformly rectilinear if the time between two events is less than a first duration (for example a constant duration acting as a minimum threshold).

In a step E2, a distance density f_{D}_{₁₂}, is determined. By using the total probability formula and the hypotheses mentioned above, it can be proved that a pair of variables (Xᵢ, Yᵢ) follows a density law fᵢ. Naturally, other calculation methods can be used to obtain the distance density f_{D}_{₁₂}.

It is then posed D₁₂=\sqrt{(X₂−X₁)²+(Y₂−Y₁)²} where D₁₂ is the random variable giving the distance travelled by the mobile terminal between the times t₁ and t₂.

The random variable D₁₂ follows a density law f_{D}_{₁₂}, such that: ∀d∈ [symbol] ₊:

$${f}_{{D}_{12}} ( d ) = {\int }_{{ℝ}^{3}} {f}_{1} ( {x}_{1} , {y}_{1} ) {\sum }_{\pm } {f}_{2} ( {x}_{2} , {y}_{1} \pm \sqrt{{d}^{2} - {( {x}_{2} - {x}_{1} )}^{2}} ) \frac{d {𝕝}_{\{ d > \vert {x}_{2} - {x}_{1} \vert \}} ( {x}_{1} , {x}_{2} , d )}{\sqrt{{d}^{2} - {( {x}_{2} - {x}_{1} )}^{2}}} {dx}_{1} {dx}_{2} {dy}_{1}$$

Since the mobile terminal is assumed to move in a uniform rectilinear motion, a velocity density is calculated using the following change of variable

$$v = \frac{d}{{t}_{2} - {t}_{1}}$$

which gives:

$${f}_{{V}_{12}} ( v ) = ( {t}_{2} - {t}_{1} ) {f}_{{D}_{12}} ( d ) \qquad ( 1 )$$

By integrating this density over a distance interval [dₐ, d_{b}] included in [symbol] ₊ and noting

$$E ( {d}_{a} , {d}_{b} ) = \{ ( x , y , {x}^{′} , {y}^{′} ) ∈ {ℝ}^{4} / \vert {y}^{′} - y \vert \leq \sqrt{{d}_{b}^{2} - {( {x}^{′} - x )}^{2}} et {d}_{a} \leq \vert {x}^{′} - x \vert \leq {d}_{b} \} ,$$

it is obtained, after inversion and with the help of changes of variables y₂=y₁±\sqrt{d²−(x₂−x₁)²} in the appropriate integrals, we obtain a form that is much more convenient for numerical calculation:

$${\int }_{{d}_{a}}^{{d}_{b}} {f}_{{D}_{12}} ( d ) d d = {\int }_{{ℝ}^{4}} {f}_{1} ( {x}_{1} , {y}_{1} ) {f}_{2} ( {x}_{2} , {y}_{2} ) {𝕝}_{E ( {d}_{a} , {d}_{b} )} ( {x}_{1} , {x}_{2} , {y}_{1} , {y}_{2} ) {dx}_{1} {dx}_{2} {dy}_{1} {dy}_{2} \qquad ( 2 )$$

One method for calculating this distance density f_{D}_{₁₂} can be to create a spatial mesh of two geographic maps representing a coverage area of a base station associated with an antenna Aᵢ. Each pixel pₖ of this mesh is associated with a support probability by the antenna Ai conditioned by the presence of the mobile terminal at this pixel P(Aᵢ|(X,Y)∈pₖ). Such information is provided by the likelihood map of support by a cell associated with the antenna Aᵢ.

Hence, in some embodiments, at the end of a step E2, a distance density f_{D}_{₁₂} can be obtained and, therefore, by means of the change of variable

$$v = \frac{d}{{t}_{2} - {t}_{1}} ,$$

a speed density can be obtained for a pair of network events ER1, ER2.

In order to improve the accuracy of the value of the mobile terminal movement speed, steps E1 and E2 can be repeated, in some embodiments, for a plurality of pairs of events (on the condition, for example, that the times t; associated with each event fall within the time window of 15 minutes defined above). Naturally, the length of the time window can take on any other value depending on requirements, legislation, etc.

Hence, once all the pairs of events ERᵢ, ERⱼ within the time window have been formed, steps E1 and E2 are carried out for each of these pairs of events ERᵢ, ERⱼ. At the end of these various iterations of steps E1 and E2, it is possible to obtain as many mobile terminal movement speed densities as there are pairs of events ERᵢ, ERⱼ.

In some embodiments, the method for obtaining a value of a movement speed of a mobile terminal may comprise (in a step E3) a combination of the different movement speed densities of the mobile terminal obtained. Such a combination may, for example, result in a probability density for the average movement speed of the mobile terminal for a duration less than or equal to that of the time window considered.

Such embodiments may, for example, be based on an additional assumption. Hence, it can be assumed that there is a speed law relating to the movement of the mobile terminal. For example, it can be assumed that this speed law relating to the movement of the mobile terminal can be obtained from the different movement speed densities of the mobile terminal corresponding to the different pairs of events ERᵢ, ERⱼ.

In the detailed embodiments, to obtain the probability density of the average movement speed of the mobile terminal over the duration of the time window considered, it is possible, for example, to consider two pairs of events (a first pair of events C₁ constituted by events ER1 and ER2 and a second pair of events C₂ constituted by events ER3 and ER4), as well as the corresponding movement speed densities of the mobile terminal obtained at the end of the implementation of steps E1 and E2, and noted respectively V₁ and V₂.

Note V the random variable representing the average movement speed density of the mobile terminal, which it is sought to be obtained from the movement speed densities of the mobile terminal V₁ and V₂.

Knowing the following property:

$$∀ ( v , {v}^{′} ) ∈ {ℝ}_{+}^{2} , P ( V ∈ [ v , {v}^{′} ] ) > 0 ⇔ P ( {V}_{1} ∈ [ v , {v}^{′} ] ) > 0 ) \qquad ( 3 )$$

$$et P ( {V}_{2} ∈ [ v , {v}^{′} ] ) > 0 )$$

which says that for the event, in the sense of probabilities, “V∈[v, v′]” occurs with a non-null probability, it is necessary and sufficient that the events, in the sense of probabilities, “Vᵢ∈[v, v′]” occur with a non-null probability.

By noting that the movement speed densities of the mobile terminal V₁ and V₂ are independent of each other by construction, property (3) can then be rewritten as:

$$∀ ( v , {v}^{′} ) ∈ {ℝ}_{+}^{2} , P ( V ∈ [ v , {v}^{′} ] ) > 0 ⇔ P ( {V}_{1} > 0 ⋂ {V}_{2} > 0 ) > 0 \qquad ( {3}^{′} )$$

35 If we consider the average speed density of the mobile terminal V verifying equation (3′) as the result of two random experiments whose order does not matter, it is then possible to write, by noting I_{v,v′}=[v, v′] for all v, v′:

$$P ( V ∈ {I}_{v , {v}^{′}} ) = P ( {V}_{1} , {V}_{2} ∈ {I}_{v , {v}^{′}}^{2} ) + P ( {V}_{1} ∉ {I}_{v , {v}^{′}} ⋂ {V}_{2} ∈ {I}_{v , {v}^{′}} ) {𝕝}_{\{ P ( {V}_{1} ∈ {I}_{v , {v}^{′}} ) > 0 \}} ( v , {v}^{′} ) + P ( {V}_{1} ∈ {I}_{v , {v}^{′}} ⋂ {V}_{2} ∉ {I}_{v , {v}^{′}} ) {𝕝}_{\{ P ( {V}_{2} ∈ {I}_{v , {v}^{′}} ) > 0 \}} ( v , {v}^{′} )$$

which can be rewritten, thanks to the independence of the two movement speed densities of the mobile terminal V₁ and V₂, in the form:

$$P ( V ∈ {I}_{v , {v}^{′}} ) = ( 1 - P ( {V}_{1} ∉ {I}_{v , {v}^{′}} ) P ( {V}_{2} ∉ {I}_{v , {v}^{′}} ) ) {𝕝}_{\{ P ( {V}_{1} ∈ {I}_{v , {v}^{′}} ∩ {V}_{2} ∈ {I}_{v , {v}^{′}} ) > 0 \}} ( v , {v}^{′} ) \qquad ( 4 )$$

Such an expression can easily be generalised to n independent mobile terminal movement speed densities, where n corresponds to the number of event pairs Cᵢ constituted for a given time window.

Equation (4) can then be normalised to verify the following property:

P(V∈ [symbol] ₊)=1 which means that the average movement speed of the mobile terminal being searched for is positive or null.

FIG. 4 shows an example of such an average movement speed density of the mobile terminal. More particularly, FIG. 4 shows such an average movement speed density of the mobile terminal when the user of this mobile terminal is on a high-speed train.

In some embodiments, from the average movement speed density of the mobile terminal as determined for example above, it is possible to obtain, in a step E4, a value of an average movement speed of the mobile terminal by calculating the expectation of a probability law associated with the average movement speed density of the mobile terminal V.

In this way, a 95% confidence interval can be determined, for example, to obtain a value for the average movement speed of the mobile terminal over the time window considered. Naturally, other methods of determining a value for the average movement speed of the mobile terminal over the time window considered can be implemented in some embodiments, such as calculating the median.

In some embodiments, to mitigate the phenomenon of network oscillation, the times tᵢ and tⱼ corresponding respectively to a network event ERᵢ and to an event ERⱼ constituting a pair Cᵢ of network events, can be chosen to be separated by a minimum duration. This means that the time elapsed between the occurrence of the event ERᵢ and the event ERⱼ is greater than or equal to a first duration. Such a duration, acting as a threshold, can for example, when the time window considered lasts 15 minutes, be set in the order of a few seconds to a few minutes (for example 3 to 9 minutes), such as a duration of 5 or 6 minutes. Naturally, other values of this first duration can be envisaged.

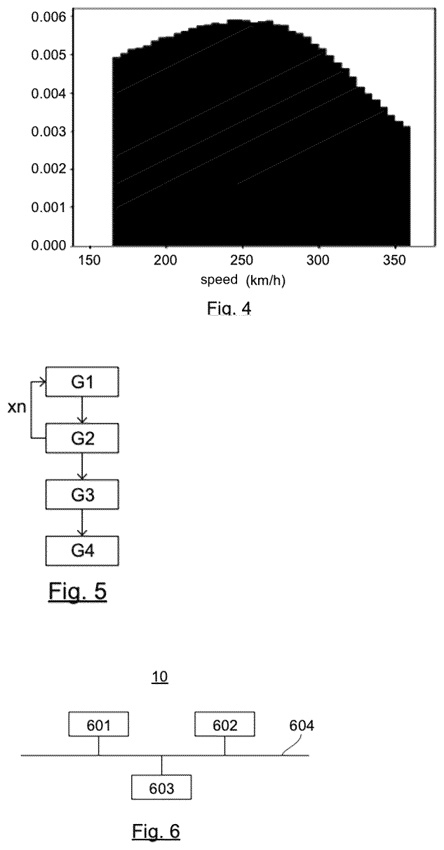

FIG. 5 shows a diagram of the steps of a method for obtaining a value of a variable representative of a movement of a mobile terminal in a second example of implementation. In this second example, the variable representative of a movement of the mobile terminal is the movement direction.

This method for obtaining a value for the movement direction of a mobile terminal relies on the use of signalling data relating to mobile terminals, and therefore to their users, its implementation may comply with constraints on anonymisation, or pseudoanonymisation, in the short term. Hence, the calculations to be performed use signalling data whose history does not exceed a certain duration. Such as duration is 15 minutes, for example.

In a first step G1 of the method for obtaining a value of a movement direction of a mobile terminal consists of selecting a first network event ER1 and a second network event ER2 from a plurality of network events ERᵢ involving the mobile terminal.

The first and second network events ER1, ER2 occur respectively at times tᵢ and t₂ and involve the antennas A₁ and A₂ carried by two different base stations.

For i∈{1,2} we denote (Xᵢ, Yᵢ) the random variables respectively giving the longitude and latitude of the mobile terminal at time tᵢ.

In a step G2, a direction density f_{θ}_{_{12′}} is determined. By using the total probability formula and the hypotheses mentioned above, it can be proved directly that the pair of variables (Xᵢ, Yᵢ) follows a density law fᵢ.

It is then posed

$${θ}_{12} = arctan ( \frac{{Y}_{2} - {Y}_{1}}{{X}_{2} - {X}_{1}} )$$

where θ₁₂ is the random variable giving the movement direction of the mobile terminal between the times t₁ and t₂.

The random variable θ₁₂ follows a density law f_{θ}_{₁₂}, such that: ∀θ∈[0, 2π[:

$${f}_{{θ}_{12}} ( θ ) = {\int }_{{ℝ}^{3}} {f}_{1} ( {x}_{1} , {y}_{1} ) {f}_{2} ( {x}_{2} , {y}_{1} + ( {x}_{2} - {x}_{1} ) tan ( θ ) ) ( {x}_{2} - {x}_{1} ) ( 1 + {tan}^{2} ( θ ) ) {𝕝}_{\{ {x}_{2} \neq {x}_{1} \}} {𝕝}_{\{ θ \neq ( k + \frac{1}{2} ) π , k ∈ ℤ \}} {dx}_{1} {dx}_{2} {dy}_{1}$$

Since the mobile terminal is assumed to move in a uniform rectilinear motion, a direction density is calculated as follows:

By integrating this density over an angle interval [θₐ, θ_{b}] included in

$$[ 0 , 2 π [ \backslash \{ ( k + \frac{1}{2} ) π , k ∈ ℤ \} ,$$

and noting E(θₐ, θ_{b})={(x, y, x′, y′)∈ [symbol] ⁴. y′ϵ[y+ (x′−x)tan(θₐ), (x′−x)tan(θ_{b})]}, it is obtained, after inversion and by means of the changes of variables y₂=y₁+(x₂−X₁)tan(θ) in the appropriate integrals, a form that is much more convenient for numerical calculation:

$${\int }_{{θ}_{a}}^{{θ}_{b}} {f}_{{θ}_{12}} ( θ ) d θ = {\int }_{{ℝ}^{4}} {f}_{1} ( {x}_{1} , {y}_{1} ) {f}_{2} ( {x}_{2} , {y}_{2} ) {𝕝}_{E ( {θ}_{a} , {θ}_{b} )} ( {x}_{1} , {x}_{2} , {y}_{1} , {y}_{2} ) {dx}_{1} {dx}_{2} {dy}_{1} {dy}_{2} \qquad ( 2 )$$

Thus, at the end of a step G2, a direction density f_{θ}_{₁₂} is obtained for a pair of network events ER1, ER2.

In order to improve the accuracy of the value of the movement direction of the mobile terminal, steps G1 and G2 can also be repeated for a plurality of pairs of events on the condition that the times tᵢ associated with each event fall within the time window of 15 minutes defined above in relation to the embodiment of FIG. 1.

Hence, once all the pairs of events ERᵢ, ERⱼ within the time window have been formed, steps G1 and G2 are carried out for each of these pairs of events ERᵢ, ERⱼ. At the end of these various iterations of steps G1 and G2, as many movement direction densities of the mobile terminal are obtained as there are pairs of events ERᵢ, ERⱼ.

In a step G3, the different movement direction densities of the mobile terminal obtained are combined. The result of such a combination is a probability density of the average movement direction of the mobile terminal over the duration of the time window considered.

To achieve this, a further assumption needs to be added. Hence, it is assumed that there is a direction law relating to the movement of the mobile terminal. It is assumed that this direction law relating to the movement of the mobile terminal can be obtained from the different movement direction densities of the mobile terminal corresponding to the different pairs of events ERᵢ, ERⱼ.

To obtain the probability density of the average movement direction of the mobile terminal over the duration of the time window considered, two pairs of events are considered, a first pair of events C₁ constituted by events ER1 and ER2 and a second pair of events C₂ constituted by events ER3 and ER4, as well as the corresponding movement direction densities of the mobile terminal obtained at the end of the implementation of steps G1 and G2, and noted respectively θ₁ and θ₂.

Note θ the random variable representing the average movement direction density of the mobile terminal, which it is sought to be obtained from the movement direction densities of the mobile terminal θ₁ and θ₂.

Knowing the following property:

$$∀ ( θ , {θ}^{′} ) ∈ [ 0 , 2 π {[}^{2} , P ( θ ∈ [ θ , {θ}^{′} ] ) > 0 ⇔ P ( {θ}_{1} ∈ [ θ , {θ}^{′} ] ) > 0 ) \qquad ( 3 )$$

$$et P ( {θ}_{2} ∈ [ θ , {θ}^{′} ] ) > 0 )$$

which says that for the event, in the sense of probabilities, “θ∈[θ,θ′]” occurs with a non-null probability, it is necessary and sufficient that the events, in the sense of probabilities, “θᵢ∈[θ,θ′]” occur with a non-null probability.

By noting that the movement direction densities of the mobile terminal θ₁ and θ₂ are independent of each other by construction, property (3) can then be rewritten as:

$$∀ ( θ , {θ}^{′} ) ∈ [ 0 , 2 π {[}^{2} , P ( θ ∈ [ θ , {θ}^{′} ] ) > 0 ⇔ P ( {θ}_{1} > 0 ⋂ {θ}_{2} > 0 ) > 0 \qquad ( {3}^{′} )$$

If we consider the average direction density of the mobile terminal θ verifying equation (3′) as the result of two random experiments whose order does not matter, it is then possible to write, by noting I_{θ,θ′}=[θ,θ′] for all θ,θ′:

$$P ( θ ∈ {I}_{θ , {θ}^{′}} ) = P ( {θ}_{1} , {θ}_{2} ∈ {I}_{θ , {θ}^{′}}^{2} ) + P ( {θ}_{1} ∉ {I}_{θ , {θ}^{′}} ⋂ {θ}_{2} ∈ {I}_{θ , {θ}^{′}} ) {𝕝}_{\{ P ( {θ}_{1} ∈ {I}_{θ , {θ}^{′}} ) > 0 \}} ( θ , {θ}^{′} ) + P ( {θ}_{1} ∈ {I}_{θ , {θ}^{′}} ⋂ {θ}_{2} ∉ {I}_{θ , {θ}^{′}} ) {𝕝}_{\{ P ( {θ}_{2} ∈ {I}_{θ , {θ}^{′}} ) > 0 \}} ( θ , {θ}^{′} )$$

which can be rewritten, thanks to the independence of the two movement direction densities of the mobile terminal θ₁ and θ₂, in the form:

$$P ( θ ∈ {I}_{θ , {θ}^{′}} ) = ( 1 - P ( {θ}_{1} ∉ {I}_{θ , {θ}^{′}} ) P ( {θ}_{2} ∉ {I}_{θ , {θ}^{′}} ) ) {𝕝}_{\{ P ( {θ}_{1} ∈ {I}_{θ , {θ}^{′}} {∩θ}_{2} ∈ {I}_{θ , {θ}^{′}} ) > 0 \}} ( θ , {θ}^{′} ) \qquad ( 4 )$$

Such an expression can easily be generalised to n independent mobile terminal movement direction densities, where n corresponds to the number of event pairs Cᵢ constituted for a given time window.

In some embodiments, equation (4) can then be normalised to verify the following property:

P(θ∈[0, 2π[)=1, which means that the average movement direction of the mobile terminal being searched for is in the interval [0, 2π[.

In some embodiments, from the average movement direction density of the mobile terminal thus determined, it is possible to obtain, in a step G4, a value of an average movement direction of the mobile terminal by calculating the expectation of a probability law associated with the average movement direction density of the mobile terminal θ.

Insofar as the direction densities of the mobile terminal are circular densities, the calculation of the expectation and standard deviation must be adapted.

To do this, it is necessary to set: m₁=∫_{Γ}P(θ)e^{iθ}dθ, where Γ is any interval of range 2π.

The average movement direction of the mobile terminal is then expressed as θ̅=arg(m₁).

There are several possible methods for calculating the standard deviation, most often using the modulus of m₁ and an analogy with a circular normal distribution. In an example, the following estimator of the standard deviation is given by:

$${σ}_{θ} = arcsin ( ε ) [ 1 + ( \frac{2}{\sqrt{3}} - 1 ) {ε}^{3} ] ,$$

where ϵ={square root over (1−(Re(m₁)²+Im(m₁)²))} where Re(m1) and Im(m1) denote the real part and imaginary part of m1 respectively. This standard deviation is then used to determine a 95% confidence interval.

FIG. 6 illustrates a device 10 capable of implementing certain steps of the previously described solution.

A device 10 may comprise at least one hardware processor 601 correspond to the processor μPr of FIG. 1, a storage unit 602 and an interface 603, which are connected to each other via a bus 604. Naturally, the components of the device 10 can be connected by means of a connection other than a bus.

The processor 601 controls the operations of the device 10. The storage unit 602 stores at least one program for implementing the method that is the subject of the invention, in its various embodiments to be executed by the processor 601, and various data, such as parameters used for calculations performed by the processor 601, intermediate data for calculations performed by the processor 601, etc. The processor 601 may be formed by any known and appropriate hardware or software, or by a combination of hardware and software. For example, the processor 601 can be formed by a dedicated hardware such as a processing circuit, or by a programmable processing unit such as a Central Processing Unit which executes a program stored in a memory thereof.

The storage unit 602 may be formed by any appropriate means capable of storing the program or programs and data in a computer-readable manner. Examples of storage devices 602 include non-transitory computer-readable storage media such as semiconductor memory devices, and magnetic, optical or magneto-optical recording media loaded into a read/write device.

Interface 603 provides an interface between device 10 and other equipment in the radio communication network.

1. An obtaining method implemented by a device and comprising:
obtaining a value of a variable representing a movement of a mobile terminal from a probability density of said variable representative of a movement of mobile terminal according to a first position of the mobile terminal during a first timestamped network event, obtained by using first connection probabilities, on a first coverage area of a first base station with which the mobile terminal interacted during said first network event, from said mobile terminal to said first base station, and to a second position of the mobile terminal during a second timestamped network event obtained by using second connection probabilities, on a second coverage area of a second base station with which the mobile terminal interacted during said second network event, from said mobile terminal to said second base station.

2. The obtaining method according to claim 1 wherein the first event and the second event are selected from a plurality of network events involving the mobile terminal, occurred during a first time window.

3. The obtaining method according to claim 1 comprising at least two iterations of obtaining said probability density of said variable representative of a movement of the mobile terminal and further comprising determining a combined probability density of said variable representative of a movement of the mobile terminal by combining the probability densities of said variable representative of a movement of the mobile terminal determined during each of said iterations, the value of said variable representative of a movement of the mobile terminal being thus obtained from said average probability density.

4. The obtaining method according to claim 1 wherein the first event and the second event are temporally spaced by at least one first duration.

5. The obtaining method according to claim 1 wherein the variable representative of a movement of a mobile terminal is a movement speed of the mobile terminal.

6. The obtaining method according to claim 5 wherein the probability density of said variable representative of a movement of the mobile terminal is determined by using a density of a distance travelled by the mobile terminal, obtained according to said first connection probabilities and to said second connection probabilities, and to a duration separating the first and second events.

7. The obtaining method according to claim 1 wherein the variable representative of a movement of a mobile terminal is a movement direction of the mobile terminal.

8. The obtaining method according to claim 7 wherein the probability density of said variable representative of a movement of the mobile terminal is determined by using a density of a value of an angle representative of a movement direction of the mobile terminal obtained according to said first connection probabilities and to said second connection probabilities.

9. An electronic device capable of obtaining a value of a variable representative of a movement of a mobile terminal, wherein said device comprises:
at least one processor adapted to:
obtain a value of a variable representing a movement of a mobile terminal from a probability density of said variable representative of a movement of the mobile terminal according to a first position of the mobile terminal during a first timestamped network event, obtained by using first connection probabilities, on a first coverage area of a first base station with which the mobile terminal interacted during said first network event, from said mobile terminal to said first base station, and to a second position of the mobile terminal during a second timestamped network event obtained by using second connection probabilities, on a second coverage area of a second base station with which the mobile terminal interacted during said second network event, from said mobile terminal to said second base station.

10. A non-transitory computer readable medium comprising a computer program product stored thereon comprising program code instructions for implementing, when executed by a processor, a method for obtaining a value of a variable representative of a movement of a mobile terminal, said method comprising:
obtaining a value of a variable representative of a movement of a mobile terminal from determining a probability density of said variable representative of a movement of the mobile terminal according to a first position of the mobile terminal during a first timestamped network event, obtained by using first connection probabilities, on a first coverage area of a first base station with which the mobile terminal interacted during said first network event, from said mobile terminal to said first base station, and to a second position of the mobile terminal during a second timestamped network event obtained by using second connection probabilities, on a second coverage area of a second base station with which the mobile terminal interacted during said second network event, from said mobile terminal to said second base station.

11. The electronic device according to claim 9 wherein the at least one processor is adapted to select the first event and the second event from a plurality of network events involving the mobile terminal, occurred during a first time window.

12. The electronic device according to claim 9 wherein the at least one processor is adapted for at least two iterations of obtaining said probability density of said variable representative of a movement of the mobile terminal and further determining a combined probability density of said variable representative of a movement of the mobile terminal by combining the probability densities of said variable representative of a movement of the mobile terminal determined during each of said iterations, the value of said variable representative of a movement of the mobile terminal being thus obtained from said average probability density.

13. The electronic device according to claim 9 wherein the first event and the second event are temporally spaced by at least one first duration.

14. The electronic device according to claim 9 wherein the variable representative of a movement of a mobile terminal is a movement speed of the mobile terminal.

15. The electronic device according to claim 14 wherein the probability density of said variable representative of a movement of the mobile terminal is determined by using a density of a distance travelled by the mobile terminal, obtained according to said first connection probabilities and to said second connection probabilities, and to a duration separating the first and second events.

16. The electronic device according to claim 9 wherein the variable representative of a movement of a mobile terminal is a movement direction of the mobile terminal.

17. The electronic device according to claim 16 wherein the probability density of said variable representative of a movement of the mobile terminal is determined by using a density of a value of an angle representative of a movement direction of the mobile terminal obtained according to said first connection probabilities and to said second connection probabilities.
